(19) United States
(12) Patent Application Publication
(10) Pub. No.: US 2024/0165895 A1
(43) Pub. Date: May 23, 2024

(54) Composite Manufacturing with Reduced Manufacturing Time

(71) Applicant: The Boeing Company, Arlington, VA (US)

(72) Inventors: Daniel James Cowan, North Charleston, SC (US); Brian S. Carpenter, Summerville, SC (US); Markus G. Peter, North Charleston, SC (US)

(21) Appl. No.: 18/462,689

(22) Filed: Sep. 7, 2023

Related U.S. Application Data
(60) Provisional application No. 63/384,154, filed on Nov. 17, 2022.

(51) Int. Cl. B29C 70/54; B29C 33/60

(52) U.S. Cl. CPC B29C 70/54; B29C 33/60; B29C 70/545; B29K 2307/04

(57) ABSTRACT

Methods of forming a composite product are presented. A releasable gap filler is applied within a recess of a mold. An uncured composite material is applied directly over the releasable gap filler and onto the mold. The uncured composite material is cured to form a cured composite material on the mold. The cured composite material is removed from the mold and the releasable gap filler.

### CROSS-REFERENCE TO RELATED APPLICATION

This application claims the benefit of U.S. Provisional Patent Application Ser. No. 63/384,154, filed Nov. 17, 2022, and entitled “Composite Manufacturing with Reduced Manufacturing Time,” which is incorporated herein by reference in its entirety.

### BACKGROUND INFORMATION

### 1. Field

The present disclosure relates generally to composite manufacturing and more specifically to reducing manufacturing time by reducing mold preparation time between curing cycles.

### 2. Background

Aircraft are being designed and manufactured with greater and greater percentages of composite materials. Composite materials are used in aircraft to decrease the weight of the aircraft. This decreased weight improves performance features such as payload capacities and fuel efficiencies. Further, composite materials provide longer service life for various components in an aircraft.

Composite materials are strong, light-weight materials created by combining two or more constituent materials. For example, a composite material may include reinforcing fibers bound in polymer resin matrix. The fibers can take the form of a unidirectional tape, woven cloth or fabric, or a braid.

In manufacturing composite structures, layers of composite material are laid up on a tool and cured upon exposure to elevated temperature and pressure. The cured composite material can be removed from the curing tool prior to performing manufacturing operations such as machining operations on the cured composite material. Some cure tools enable machining operations on cured composite material on the cure tool. These cure tools have recesses for the trimming tools to enable machining operations without undesirably impacting the cure tool.

Preparing conventional cure tools for receiving the uncured composite material uses additional processing steps, additional manufacturing time, and potentially hazardous chemicals. Therefore, it would be desirable to have a method and apparatus that takes into account at least some of the issues discussed above, as well as other possible issues.

### SUMMARY

An embodiment of the present disclosure provides a method of forming a composite product. A releasable gap filler is applied within a recess of a mold. An uncured composite material is applied directly over the releasable gap filler and onto the mold. The uncured composite material is cured to form a cured composite material on the mold. The cured composite material is removed from the mold and the releasable gap filler.

Another embodiment of the present disclosure provides a method of forming a composite product. An uncured composite material is placed over and in direct contact with a releasable gap filler within a recess in a mold. The composite material is cured while in direct contact with the releasable gap filler. The cured composite material is removed from the mold, leaving the releasable gap filler within the recess.

Yet another embodiment of the present disclosure provides a method of forming a composite product. A releasable gap filler is applied into trim channels in a mold. An uncured composite material is placed onto the mold and in direct contact with the releasable gap filler. The uncured composite material is cured to form a cured composite material. The cured composite material is trimmed at locations over the trim channels in the mold such that trimming removes some releasable gap filler from the trim channels.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of an isometric view of a mold having recesses in accordance with an illustrative embodiment;

FIG. 4 is an illustration of an isometric view of a mold having releasable gap filler in the recesses in accordance with an illustrative embodiment;

FIG. 5 is an illustration of an isometric view of a composite material over the mold in accordance with an illustrative embodiment;

FIG. 6 is an illustration of an isometric view of a trimmed and drilled composite structure over the mold in accordance with an illustrative embodiment;

FIG. 7 is an illustration of an isometric view of a mold having releasable gap filler remaining in the recesses after composite material is removed in accordance with an illustrative embodiment;

FIG. 8 is a flowchart of a method of forming a composite product in accordance with an illustrative embodiment;

FIG. 9 is a flowchart of a method of forming a composite product in accordance with an illustrative embodiment;

FIG. 10 is a flowchart of a method of forming a composite product in accordance with an illustrative embodiment;

FIG. 11 is an illustration of an aircraft manufacturing and service method in a form of a block diagram in accordance with an illustrative embodiment ; and

FIG. 12 is an illustration of an aircraft in a form of a block diagram in which an illustrative embodiment may be implemented.

### DETAILED DESCRIPTION

The illustrative examples recognize and take into account one or more different considerations. For example, the illustrative examples recognize and take into account that mandrel segments, utilized to fabricate CFRP sections of an airplane, require groove filler to be applied into large trim grooves and hole machining locations that are required for the trim operations. The illustrative examples recognize and take into account that the current materials that are on the market for these applications are not releasable from the cured composite such as BMS8-276 prepreg carbon fiber reinforced polymer (CFRP). The illustrative examples recognize and take into account that these currently used materials require an additional production processing step with an application of a release agent between the CFRP part and the groove filler. The illustrative examples recognize and take into account that this additional processing step adds considerable flow time per component/airplane build.

The illustrative examples recognize and take into account that currently, various release agents are utilized to provide the required releasability of the groove filler from the carbon fiber reinforced polymer (CFRP). The illustrative examples recognize and take into account that this additional processing step adds considerable flow time per airplane.

The illustrative examples recognize and take into account that it would be desirable to eliminate additional processing steps, reduce the use of hazardous chemicals, and save manufacturing time. The illustrative examples recognize and take into account that reducing mold preparation steps could potentially result in significant flow reduction.

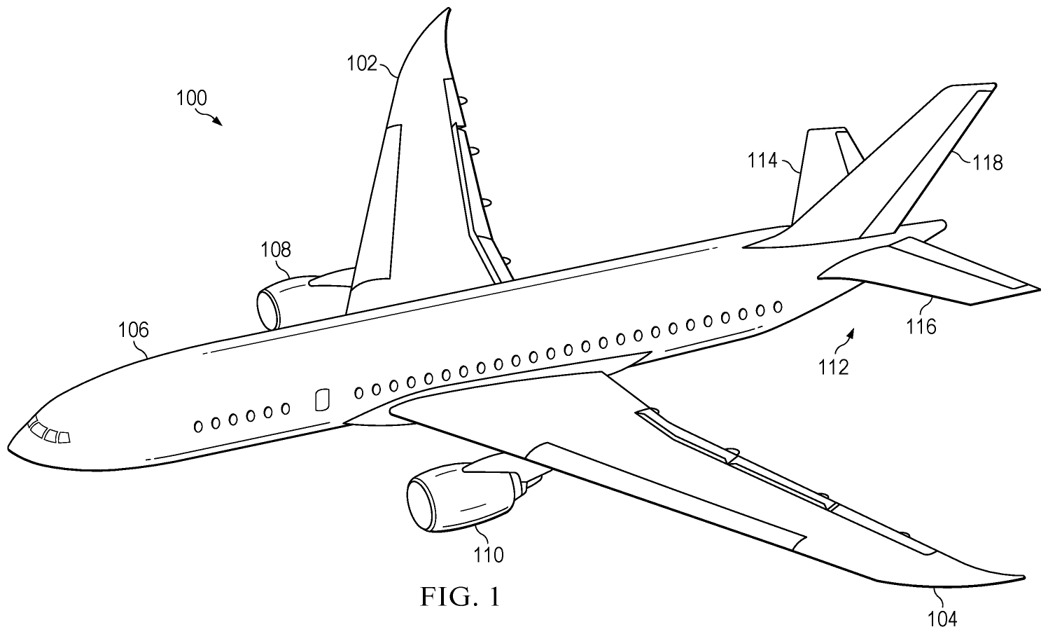

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft having components formed using the methods of the illustrative example. Aircraft 100 is an example of an aircraft having composite components formed with a reduced mold downtime.

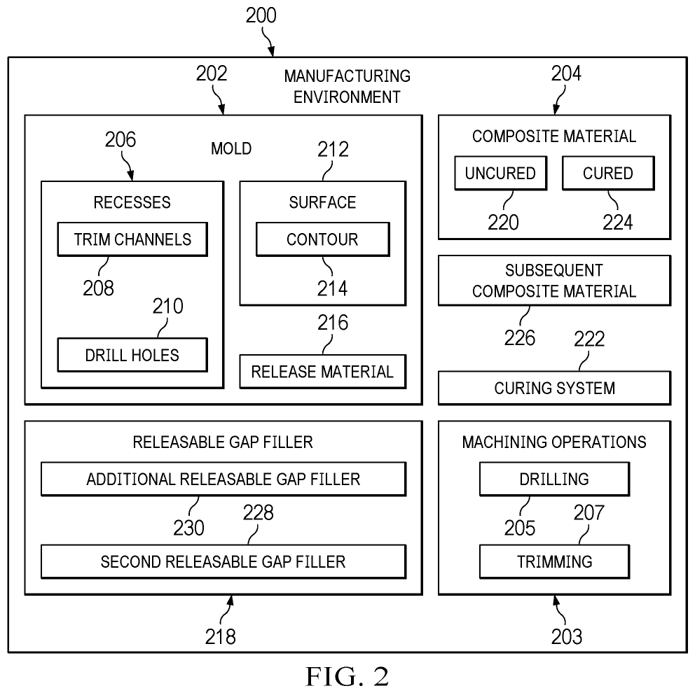

Turning now to FIG. 2, an illustration of a block diagram of a manufacturing environment is depicted in accordance with an illustrative embodiment. Components of aircraft 100 of FIG. 1 can be manufactured in manufacturing environment 200.

Manufacturing environment 200 contains mold 202 configured to hold composite material 204 during curing and machining operations 203 such as drilling 205 or trimming 207. Mold 202 has recesses 206 for accommodating machining operations 203 composite material 204. Recesses 206 comprises at least one of trim channels 208 or drill holes 210. Trim channels 208 are positioned in locations to accommodate trimming 207 of composite material 204. Trim channels 208 prevent damage to mold 202 from cutting tools during trimming 207 operations on composite material 204. Drill holes 210 are positioned in locations to accommodate drilling 205 of composite material 204. Drill holes 210 prevent damage to mold 202 during drilling 205 operations on composite material 204.

Recesses 206 are formed into surface 212 of mold 202. Surface 212 has contour 214 designed to provide an inner mold line during curing of composite material 204.

Release material 216 can optionally be applied to at least one of surface 212 or recesses 206 after a set quantity of uses. The release material 216 allows for release of cured 224 composite material 204 from mold 202.

Releasable gap filler 218 is applied into recesses 206 prior to applying composite material 204 to mold 202. Releasable gap filler 218 is configured to not adhere to composite material 204. Releasable gap filler 218 is configured to endure curing of composite material 204.

After being applied within recesses 206, releasable gap filler 218 is shaped to match contour 214 of surface 212. Releasable gap filler 218 is shaped so that releasable gap filler 218 is flush with mold 300. After shaping, releasable gap filler 218 is set/cured. Releasable gap filler 218 is then scraped clean and inspected.

Composite material 204 is applied directly over releasable gap filler 218 as uncured 220 composite material 204. Composite material 204 can be laid up onto mold 202 layer by layer or can be placed onto mold 202 in a pick and place operation.

Curing system 222 applies at least one of heat or pressure to cure composite material 204 to form cured 224 composite material 204 on mold 202. Machining operations 203 are performed on cured 224 composite material 204 on mold 202. Machining operations 203 include at least one of drilling 205 or trimming 207. Drilling 205 can be performed over drill holes 210. Trimming 207 can be performed over trim channels 208.

After performing machining operations 203 on cured 224 composite material 204, cured 224 composite material 204 is removed from mold 202. Releasable gap filler 218 within recesses 206 remains within mold 202. Releasable gap filler 218 does not adhere to cured composite material 204 when cured composite material 204 is removed from mold 202.

In some illustrative examples, remaining releasable gap filler 218 within recesses 206 is removed from mold 202 prior to applying subsequent composite material 226. Releasable gap filler 218 can be removed without sanding or other abrading methods. Releasable gap filler 218 can be removed by hand. Releasable gap filler 218 can be removed using a plastic scraper or other non-marring hand tools.

After removal of remaining releasable gap filler 218, second releasable gap filler 228 is applied in recesses 206. Second releasable gap filler 228 is then shaped, cured, scraped and inspected. Afterwards, subsequent composite material 226 is applied directly over second releasable gap filler 228.

In some illustrative examples, remaining releasable gap filler 218 is left within recesses 206. In these illustrative examples, additional releasable gap filler 230 is applied over remaining releasable gap filler 218. Additional releasable gap filler 230 is shaped to match contour 214 of surface 212. Additional releasable gap filler 230 is shaped so that additional releasable gap filler 230 is flush with mold 300. After shaping, additional releasable gap filler 230 is set/cured. In some illustrative examples, additional releasable gap filler 230 is then scraped clean and inspected. In some illustrative examples, applying additional releasable gap filler 230 can reduce manufacturing time by reducing or eliminating removal steps for releasable gap filler 218 and subsequent cleaning steps.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, in some illustrative examples, additional recesses or channels are present in mold 202 that are used for other purposes other than machining operations 203. Recesses 206 are not meant to imply any limitations the types or quantity of recesses that can be present on mold 202.

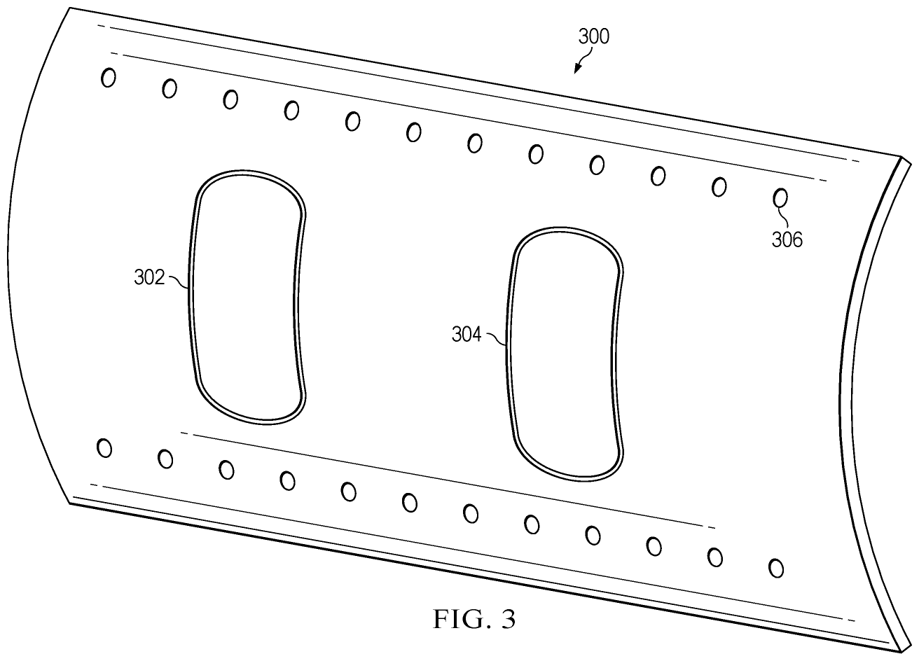

Turning now to FIG. 3, an illustration of an isometric view of a mold having recesses is depicted in accordance with an illustrative embodiment. Mold 300 is a physical implementation of mold 202 of FIG. 2. Mold 300 can be used to form portions of aircraft 100 of FIG. 1, such as portions of body 106, wing 102, or wing 104.

Mold 300 has recesses 302 configured for manufacturing of a composite structure. In this illustrative example, recesses 302 comprise trim channels 304 and drill holes 306. Recesses 302 are configured based on a specific design for a composite product. Trim channels 304 correspond to locations on a composite product that are trimmed. Drill holes 306 correspond to locations on a composite product that are drilled.

Mold 300 is formed of a material configured to support a composite material during curing. Mold 300 is formed of a material configured to withstand curing temperatures of the composite material.

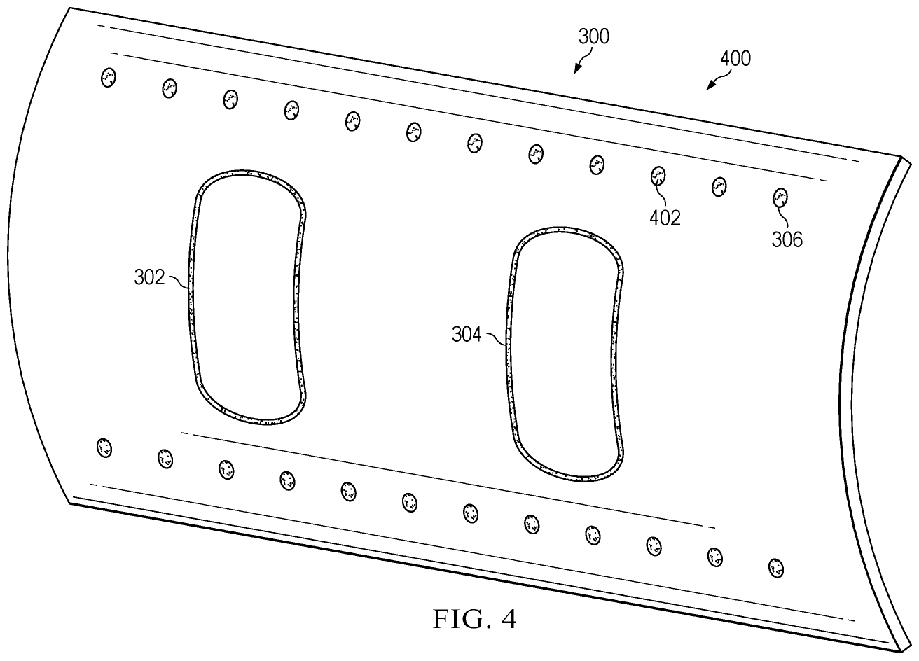

Turning now to FIG. 4, an illustration of an isometric view of a mold having releasable gap filler in the recesses is depicted in accordance with an illustrative embodiment. In view 400, releasable gap filler 402 has been applied within recesses 302 of mold 300. After application, releasable gap filler 402 is shaped so that releasable gap filler 402 is flush with mold 300. After shaping, releasable gap filler 402 is set/cured. Releasable gap filler 402 is then scraped clean and inspected.

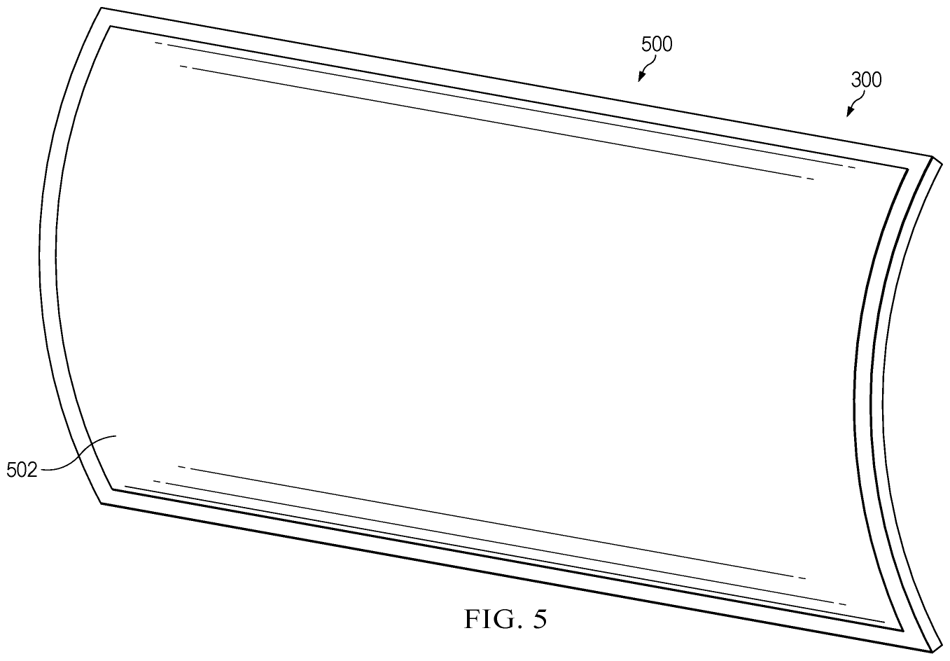

Turning now to FIG. 5, an illustration of an isometric view of a composite material over the mold is depicted in accordance with an illustrative embodiment. In view 500, composite material 502 is positioned on mold 300. Composite material 502 is positioned on mold 300 in an uncured state and cured while on mold 300.

After releasable gap filler 402 is cured and inspected, no additional release layers are added over releasable gap filler 402. Composite material 502 is placed onto mold 300 and in direct contact with releasable gap filler 402 in recesses 302.

Composite material 502 is placed onto mold 300 in an uncured state using any desirable method. In some illustrative examples, composite material 502 is pick and placed onto mold 300. In some illustrative examples, composite material 502 is laid up directly onto mold 300.

After composite material 502 is placed onto mold 300, composite material 502 is cured while on mold 300 to form a cured composite material. Due to the material properties of releasable gap filler 402, composite material 502 in cured state is later removed from mold 300 and releasable gap filler 402. Composite material 502 in cured state is removed from mold 300 without any releasable gap filler 402 on composite material 502.

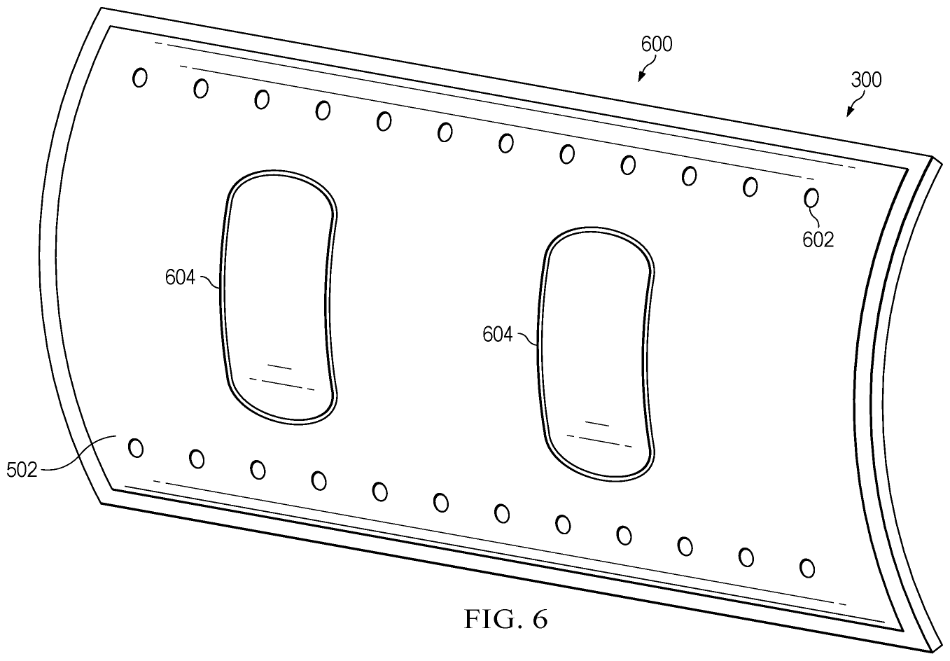

Turning now to FIG. 6, an illustration of an isometric view of a trimmed and drilled composite structure over the mold is depicted in accordance with an illustrative embodiment. In view 600, composite material 502 is cured and has undergone drilling and trimming. In view 600, composite material 502 has holes 602 drilled in composite material 502 and elements 604 trimmed in composite material 502.

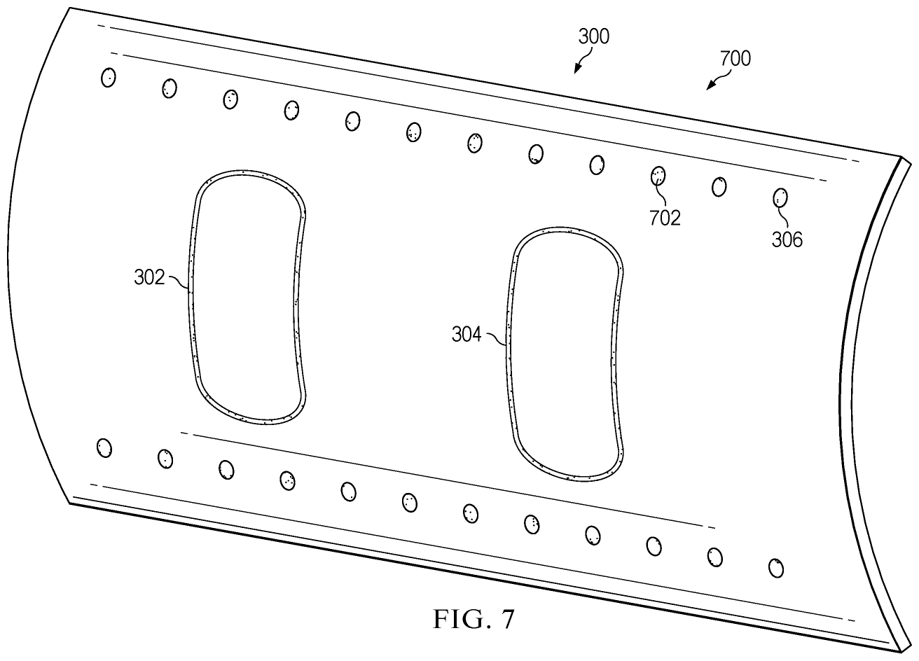

Turning now to FIG. 7, an illustration of an isometric view of a mold having releasable gap filler remaining in the recesses after composite material is removed is depicted in accordance with an illustrative embodiment. In view 700, composite material 502 has been removed from mold 300. Composite material 502 does not have any releasable gap filler 402 upon removal from mold 300. Mold 300 contains all remaining releasable gap filler 402. Releasable gap filler 402 remaining in recesses 302 is less than originally applied to mold 300. Releasable gap filler 402 was impacted by trimming and drilling to remove some of releasable gap filler 402 resulting in remaining releasable gap filler 702. Remaining releasable gap filler 702 is residual gap filler remaining in the recess.

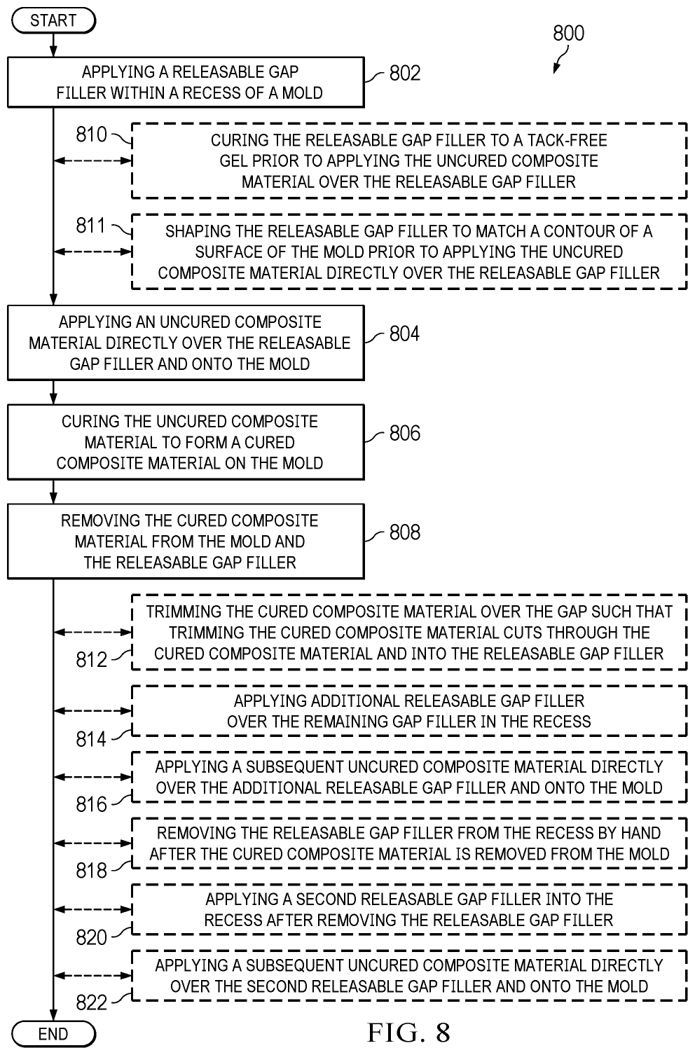

Turning now to FIG. 8, a flowchart of a method of forming a composite product is depicted in accordance with an illustrative embodiment. Method 800 can be used to form a portion of aircraft 100 of FIG. 1. Method 800 can be performed using mold 202 and releasable gap filler 218 of FIG. 2. Method 800 can be performed using mold 300 and releasable gap filler 402 of FIGS. 3-7.

Method 800 applies a releasable gap filler within a recess of a mold (operation 802). Method 800 applies an uncured composite material directly over the releasable gap filler and onto the mold (operation 804). Method 800 cures the uncured composite material to form a cured composite material on the mold (operation 806). Method 800 removes the cured composite material from the mold and the releasable gap filler (operation 808). Afterwards, method 800 terminates.

In some illustrative examples, method 800 shapes the releasable gap filler to match a contour of a surface of the mold prior to applying the uncured composite material directly over the releasable gap filler. In some illustrative examples, method 800 cures the releasable gap filler to a tack-free gel prior to applying the uncured composite material over the releasable gap filler (operation 810). In some illustrative examples, the releasable gap filler is shaped and inspected prior to applying the uncured composite material over the releasable gap filler. In some illustrative examples, method 800 shapes the releasable gap filler to match a contour of a surface of the mold prior to applying the uncured composite material directly over the releasable gap filler.

In some illustrative examples, method 800 trims the cured composite material over the recess such that trimming the cured composite material cuts through the cured composite material and into the releasable gap filler (operation 812). In some illustrative examples, trimming comprises removing edges of the cured composite material. In some illustrative examples, trimming comprises removing portions of the uncured composite material according to a design for a composite structure.

In some illustrative examples, method 800 applies additional releasable gap filler over remaining releasable gap filler in the recess after trimming (operation 814). The remaining releasable gap filler is gap filler that remains in the recess following the trimming that cuts into the releasable gap filler. By applying additional releasable gap filler over the remaining/residual releasable gap filler, removal steps can be reduced or eliminated to reduce manufacturing time.

In some illustrative examples, method 800 applies a subsequent uncured composite material directly over the additional releasable gap filler and onto the mold (operation 816). In these illustrative examples, the time between removing the cured composite material from the mold and placing the subsequent uncured composite material onto the mold can be less than removing the remaining releasable gap filler and applying a replacement releasable gap filler into the recess.

In some illustrative examples, method 800 removes the releasable gap filler from the recess by hand after the cured composite material is removed from the mold (operation 818). By removing the releasable gap filler by hand, the mold is not undesirably affected by removal tooling or removal methods. Further, having a releasable gap filler that is removable by hand can reduce the time spent on removing the gap filler.

In some illustrative examples, method 800 applies a second releasable gap filler into the recess after removing the releasable gap filler (operation 820). In some illustrative examples, method 800 applies a subsequent uncured composite material directly over the second releasable gap filler and onto the mold (operation 822).

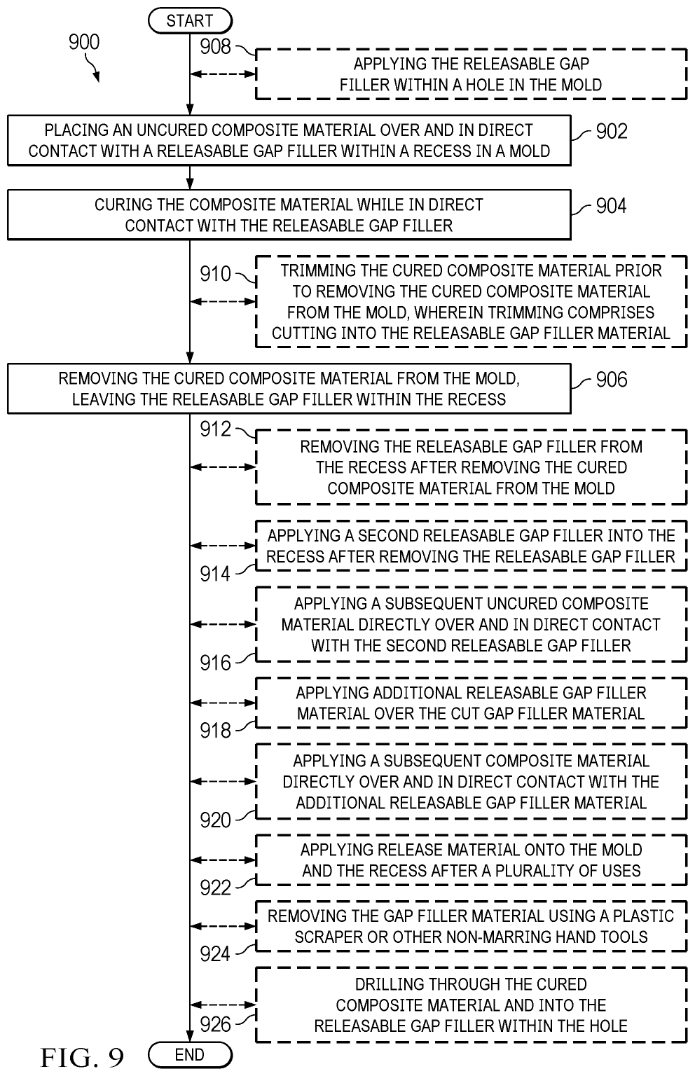

Turning now to FIG. 9, a flowchart of a method of forming a composite product is depicted in accordance with an illustrative embodiment. Method 900 can be used to form a portion of aircraft 100 of FIG. 1. Method 900 can be performed using mold 202 and releasable gap filler 218 of FIG. 2. Method 900 can be performed using mold 300 and releasable gap filler 402 of FIGS. 3-7.

Method 900 places an uncured composite material over and in direct contact with a releasable gap filler within a recess in a mold (operation 902). Method 900 cures the uncured composite material while in direct contact with the releasable gap filler to form a cured composite material (operation 904). Method 900 removes the cured composite material from the mold, leaving the releasable gap filler within the recess (operation 906). Afterwards, method 900 terminates.

In some illustrative examples, method 900 applies the releasable gap filler within a hole in the mold (operation 908). In some illustrative examples, method 900 drills through the cured composite material and into the releasable gap filler within the hole (operation 926).

In some illustrative examples, method 900 trims the cured composite material prior to removing the cured composite material from the mold, wherein trimming comprises cutting through the cured composite material and into the releasable gap filler to form cut gap filler (operation 910). In some illustrative examples, trimming comprises removing edges of the cured composite material. In some illustrative examples, trimming comprises removing portions of the uncured composite material according to a design for a composite structure.

In some illustrative examples, method 900 removes the releasable gap filler from the recess after removing the cured composite material from the mold (operation 912). In some illustrative examples, removing the releasable gap filler comprises removing the releasable gap filler using a plastic scraper or other non-marring hand tools (operation 924).

In some illustrative examples, method 900 applies a second gap filler into the recess after removing the releasable gap filler (operation 914). Second gap filler is a replacement releasable gap filler.

In some illustrative examples, method 900 applies a subsequent uncured composite material directly over and in direct contact with the second releasable gap filler (operation 916). In some illustrative examples, the subsequent uncured composite material is to be cured and receive manufacturing processes to form the same design of part as formed from the uncured composite material.

In some illustrative examples, method 900 applies additional releasable gap filler over the cut gap filler (operation 918). In these illustrative examples, additional releasable gap filler is applied to match the contour of the surface of the mold. In these illustrative examples, additional releasable gap filler is applied to refill the releasable gap filler machined from the recess. In some illustrative examples, method 900 applies a subsequent composite material directly over and in direct contact with the additional releasable gap filler (operation 920).

In some illustrative examples, method 900 applies release material onto the mold and the recess after a plurality of uses (operation 922). This release material is placed over the surface of the mold, to prevent adhesion of the uncured composite material to the surface of the mold. In some illustrative examples, the release material is applied when the releasable gap filler is not within the recess.

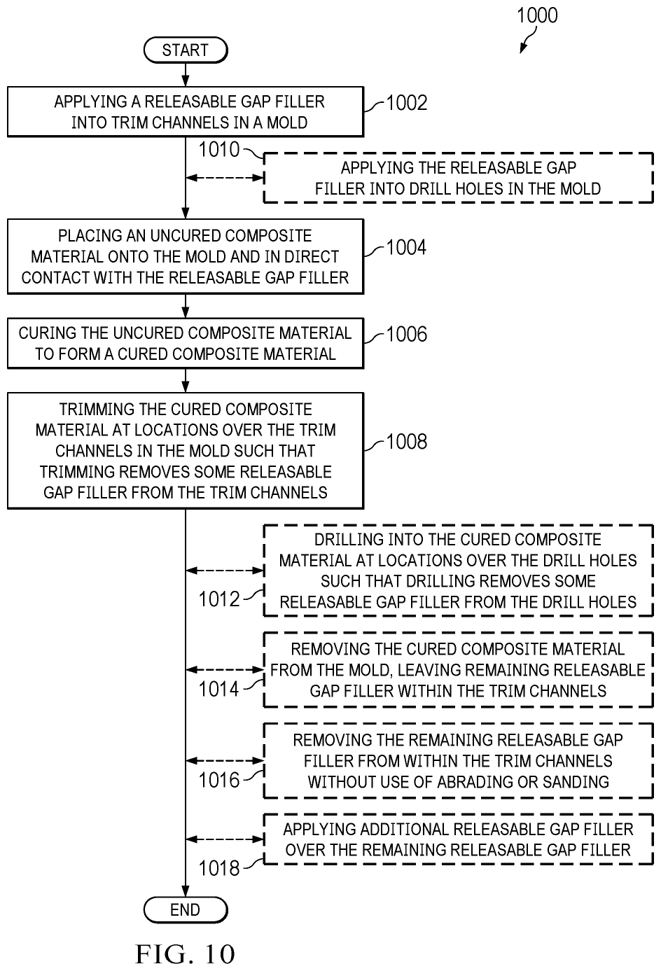

Turning now to FIG. 10, a flowchart of a method of forming a composite product is depicted in accordance with an illustrative embodiment. Method 1000 can be used to form a portion of aircraft 100 of FIG. 1. Method 1000 can be performed using mold 202 and releasable gap filler 218 of FIG. 2. Method 1000 can be performed using mold 300 and releasable gap filler 402 of FIGS. 3-7.

Method 1000 applies a releasable gap filler into trim channels in a mold (operation 1002). Method 1000 places an uncured composite material onto the mold and in direct contact with the releasable gap filler (operation 1004). Method cures the uncured composite material to form a cured composite material (operation 1006). Method 1000 trims the cured composite material at locations over the trim channels in the mold such that trimming removes some releasable gap filler from the trim channels (operation 1008). Afterwards, method 1000 terminates.

In some illustrative examples, method 1000 applies the releasable gap filler into drill holes in the mold (operation 1010). In some illustrative examples, method 1000 drills into the cured composite material at locations over the drill holes such that drilling removes some releasable gap filler from the drill holes (operation 1012).

In some illustrative examples, method 1000 removes the cured composite material from the mold, leaving remaining releasable gap filler within the trim channels (operation 1014). In some illustrative examples, method 1000 removes the remaining releasable gap filler from within the trim channels without use of abrading or sanding (operation 1016). In some illustrative examples, method 1000 applies additional releasable gap filler over the remaining releasable gap filler (operation 1018).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 810 through operation 822 may be optional. For example, operation 908 through operation 926 may be optional. For example, operation 1010 through operation 1018 may be optional.

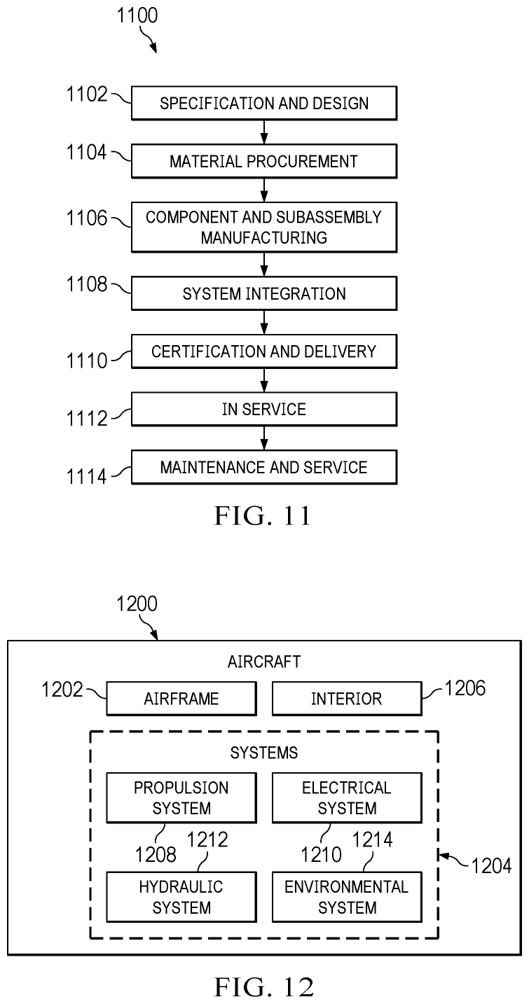

Illustrative embodiments of the present disclosure may be described in the context of aircraft manufacturing and service method 1100 as shown in FIG. 11 and aircraft 1200 as shown in FIG. 12. Turning first to FIG. 11, an illustration of an aircraft manufacturing and service method in a form of a block diagram is depicted in accordance with an illustrative embodiment. During pre-production, aircraft manufacturing and service method 1100 may include specification and design 1102 of aircraft 1200 in FIG. 12 and material procurement 1104.

During production, component and subassembly manufacturing 1106 and system integration 1108 of aircraft 1200 takes place. Thereafter, aircraft 1200 may go through certification and delivery 1110 in order to be placed in service 1112. While in service 1112 by a customer, aircraft 1200 is scheduled for routine maintenance and service 1114, which may include modification, reconfiguration, refurbishment, or other maintenance and service.

Each of the processes of aircraft manufacturing and service method 1100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 12, an illustration of an aircraft in a form of a block diagram is depicted in which an illustrative embodiment may be implemented. In this example, aircraft 1200 is produced by aircraft manufacturing and service method 1100 of FIG. 11 and may include airframe 1202 with plurality of systems 1204 and interior 1206. Examples of systems 1204 include one or more of propulsion system 1208, electrical system 1210, hydraulic system 1212, and environmental system 1214. Any number of other systems may be included.

Apparatuses and methods embodied herein may be employed during at least one of the stages of aircraft manufacturing and service method 1100. One or more illustrative embodiments may be manufactured or used during at least one of component and subassembly manufacturing 1106, system integration 1108, in service 1112, or maintenance and service 1114 of FIG. 11.

A portion of airframe 1202 of aircraft 1200 can be formed by one of method 800, method 900, or method 1000. At least one of method 800, method 900, or method 1000 can be performed during component and subassembly manufacturing 1106. A composite structure formed using one of method 800, method 900, or method 1000 can be present and utilized during in service 1112. At least one of method 800, method 900, or method 1000 can be performed during maintenance and service 1114 to form a replacement part.

The illustrative examples present methods of forming a composite structure that result in flow reduction. The illustrative examples present methods of forming a composite structure that result in elimination of additional processing steps. The illustrative examples present methods of forming a composite structure that reduces the use of hazardous chemicals. The illustrative examples present methods of forming a composite structure that saves manufacturing time.

The illustrative examples use releasable gap filler material that does not require an additional release layer. The releasable gap filler also can be removed in an easier fashion than conventional materials.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of forming a composite product:
applying a releasable gap filler within a recess of a mold;
applying an uncured composite material directly over the releasable gap filler and onto the mold;
curing the uncured composite material to form a cured composite material on the mold; and
removing the cured composite material from the mold and the releasable gap filler.

2. The method of claim 1 further comprising:
trimming the cured composite material over the recess such that trimming the cured composite material cuts through the cured composite material and into the releasable gap filler.

3. The method of claim 2 further comprising:
applying additional releasable gap filler over remaining releasable gap filler in the recess after trimming; and
applying a subsequent uncured composite material directly over the additional releasable gap filler and onto the mold.

4. The method of claim 1 further comprising:
removing the releasable gap filler from the recess by hand after the cured composite material is removed from the mold.

5. The method of claim 4 further comprising:
applying a second releasable gap filler into the recess after removing the releasable gap filler; and
applying a subsequent uncured composite material directly over the second releasable gap filler and onto the mold.

6. The method of claim 1 further comprising:
curing the releasable gap filler to a tack-free gel prior to applying the uncured composite material over the releasable gap filler.

7. The method of claim 1 further comprising:
shaping the releasable gap filler to match a contour of a surface of the mold prior to applying the uncured composite material directly over the releasable gap filler.

8. A method of forming a composite product:
placing an uncured composite material over and in direct contact with a releasable gap filler within a recess in a mold;
curing the uncured composite material while in direct contact with the releasable gap filler to form a cured composite material; and
removing the cured composite material from the mold, leaving the releasable gap filler within the recess.

9. The method of claim 8 further comprising:
removing the releasable gap filler from the recess after removing the cured composite material from the mold.

10. The method of claim 9 further comprising:
applying a second releasable gap filler into the recess after removing the releasable gap filler; and
applying a subsequent uncured composite material directly over and in direct contact with the second releasable gap filler.

11. The method of claim 8 further comprising:
trimming the cured composite material prior to removing the cured composite material from the mold, wherein trimming comprises cutting through the cured composite material and into the releasable gap filler to form cut gap filler.

12. The method of claim 11 further comprising:
applying additional releasable gap filler over the cut gap filler; and
applying a subsequent composite material directly over and in direct contact with the additional releasable gap filler.

13. The method of claim 8 further comprising:
applying release material onto the mold and the recess after a plurality of uses.

14. The method of claim 9 wherein removing the releasable gap filler comprises:
removing the releasable gap filler using a plastic scraper or other non-marring hand tools.

15. The method of claim 8 further comprising:
applying the releasable gap filler within a hole in the mold; and
drilling through the cured composite material and into the releasable gap filler within the hole.

16. A method of forming a composite product:
applying a releasable gap filler into trim channels in a mold;
placing an uncured composite material onto the mold and in direct contact with the releasable gap filler;
curing the uncured composite material to form a cured composite material; and
trimming the cured composite material at locations over the trim channels in the mold such that trimming removes some releasable gap filler from the trim channels.

17. The method of claim 16 further comprising:
applying the releasable gap filler into drill holes in the mold; and
drilling into the cured composite material at locations over the drill holes such that drilling removes some releasable gap filler from the drill holes.

18. The method of claim 17 further comprising:
removing the cured composite material from the mold, leaving remaining releasable gap filler within the trim channels.

19. The method of claim 18 further comprising:
removing the remaining releasable gap filler from within the trim channels without use of abrading or sanding.

20. The method of claim 18 further comprising:
applying additional releasable gap filler over the remaining releasable gap filler.
